(19) United States
(12) Patent Application Publication
(10) Pub. No.: US 2018/0338195 A1
(43) Pub. Date: Nov. 22, 2018

(54) Jamming Grip For Earbud Retention

(71) Applicant: The Charles Stark Draper Laboratory, Inc., Cambridge, MA (US)

(72) Inventors: Olive Rappoli, Allston, MA (US); William McFarland, Waltham, MA (US); Robert de Saint Phalle, Marblehead, MA (US); Daniel King, Watertown, MA (US); David J. Carter, Concord, MA (US)

(21) Appl. No.: 15/981,666

(22) Filed: May 16, 2018

Related U.S. Application Data
(60) Provisional application No. 62/506,986, filed on May 16, 2017.

(51) Int. Cl. H04R 1/10

(52) U.S. Cl. CPC H04R 1/1016; H04R 1/1041

(57) ABSTRACT

Current ear-inserts are custom made, have variable sizes, and often fall out of the user's ear. In an embodiment, a gripping ear-insert includes a sealed membrane having conformable material therein (e.g., within a cavity). The sealed membrane is configured to form a shape conforming to a section of the human ear upon insertion. The gripping ear-insert also includes a port configured to, in response to being activated, allow for adjustment of air pressure within the sealed membrane. The gripping ear-insert can also include a control coupled with the port, configured such that in response to the control being activated, the port evacuates air from a cavity of the sealed membrane, such that the sealed membrane retains its shape after evacuation of the air. As such, the gripping ear-insert is secured in the user's ear while the amount of air/air pressure is adjusted.

### RELATED APPLICATION

This application claims the benefit of U.S. Provisional Application No. 62/506,986, filed on May 16, 2017. The entire teachings of the above application are incorporated herein by reference.

### BACKGROUND

Commercial earbuds have been developed to improve on earbud retention and comfort for a wider range of ear sizes and shapes by custom fitting or variable sizes. Some earbud products incorporate a geometric feature that fits into the general shape of the outer ear, but variation in user ear sizes and shapes causes difficulty achieving desired and comfortable fits for all users. Some ear devices use over, on, or around ear features to hold the device in place, but these designs have disadvantages (e.g., larger size, may interfere with clothing or gear on head, etc.)

### SUMMARY

Embodiments of the present disclosure relate to an earbud device that is configured to insert into a user's ear. Embodiments of the disclosure further relate to the earbud device conforming to the user's unique ear geometry to improve earbud retention and comfort. Embodiments of the disclosure further relate to the earbud device gripping the user's ear such that the earbud does not fall out of the user's ear.

In an embodiment, a gripping ear-insert includes a sealed membrane having conformable material therein (e.g., within a cavity). The sealed membrane is configured to form a shape conforming to a section of the human ear upon insertion. The gripping ear-insert also includes a port configured to allow for adjustment of air pressure within the sealed membrane. In response to the port being activated, the port evacuates air from a cavity of the sealed membrane, such that the sealed membrane retains its shape after evacuation of the air.

In embodiments, pressure applied against the sealed membrane causes activation of the port, pushing air from the cavity of the sealed membrane through the port.

In embodiments, the port can be a miniaturized valve.

In an embodiment, the gripping ear-insert can also include a control coupled with the port, configured such that in response to the control being activated, the port evacuates air from a cavity of the sealed membrane, such that the sealed membrane retains its shape after evacuation of the air. The control can be a mechanical button or electronic button. The control can be activated in response to a wireless signal. The control can be activated in response to positioning the gripping ear-insert within the section of the human ear. The sealed membrane can be sized to fit and configured to form conforming to the shape of a human concha.

In an embodiment, the gripping ear-insert can further include an audio controller and speaker. The gripping ear-insert can also further include a wireless network controller.

In an embodiment, air pressure from soundwaves produced by the speaker can push air out of the membrane through the port. Air pressure from soundwaves produced by the speaker can cause the control to be activated.

In an embodiment, the gripping ear-insert also includes a second control coupled with the port, such that in response to the second control being activated, air enters the cavity of the sealed membrane of the gripping ear-insert. The air can enter until air pressure within the cavity is approximately equal to the environment outside of the cavity.

In an embodiment, the gripping ear-insert can include a outer layer of the sealed membrane formed of Z-Man gecko material.

In an embodiment, a method includes positioning a gripping ear-insert within at least one section of a human ear, causing a sealed membrane of the gripping ear-insert to form a shape based on a portion of the section of the human ear. The sealed membrane having conformable material therein (e.g., within a cavity). In response to activation of a control of the ear-gripping insert, the method evacuates air from a cavity of the sealed membrane of the gripping ear-insert through a port of the gripping ear-insert, such that the sealed membrane retains its shape after evacuation of the air.

### BRIEF DESCRIPTION OF THE DRAWINGS

FIG. 1 is a high-level diagram of an example embodiment of a jamming grip of the present disclosure.

FIG. 2 is a diagram illustrating nomenclature for parts of the human air, as are known by a person of ordinary skill in the art.

FIG. 3 is a diagram illustrating an example embodiment of four states of a jamming grip.

FIG. 4 is a diagram illustrating a jamming grip having a speaker within.

FIG. 5A is a diagram illustrating additional features of an embodiment of the jamming grip including valve activation controls.

FIG. 5B is a diagram illustrating an example embodiment of the restoring air pressure control.

FIG. 5C is a diagram illustrating an example embodiment of the restoring air pressure control.

### DETAILED DESCRIPTION

A description of example embodiments follows.

Current earbuds and in-ear earphones require custom plastic moldings to fit the unique shape of a user's ear. Custom molding is an expensive process, however, so consumer earbuds and earphones are offered in one size, or come with variable size attachments (e.g., small, medium, or large). However, even with variable sizing, current earbuds or in-ear earphones do not conform to the unique shape of the user's ear. Embodiments of the present disclosure solve this problem by providing a earbud or in-ear earphone that conforms to the user's ear upon insertion and uses a jamming grip to stay within the user's ear.

Jamming grips are currently used by universal robotic end effectors. Such jamming grips in universal robotic end effectors are capable of conforming around, gripping, and lifting/moving small, delicate, or irregularly shaped objects. These robotic systems physically apply the universal robotic end effectors to the object to be moved, and remove air (e.g., apply a vacuum to) from end effector. The removal of air from the end effector creates a hard grip between the end effector and the object. Pressure can be restored within the end effector to release the object. However, such universal robotic arm end effectors are large, and traditionally employ powered vacuum pumps or other large and powered means for reducing or restoring pressure.

Embodiments of the present disclosure relate to a gripping ear-insert that employs a jamming grip having granular, porous, or conformable material to mold to and retain the shape of a user's outer ear (e.g., the concha, the tragus, the anti-tragus), for the purpose of fitting and securing an earbud device in place. The jamming grip includes a sealed elastic membrane filled with granular material (e.g., coffee grounds) or other conformable material (e.g., memory foam or cotton). In response to the jamming grip being inserted into the user's ear, the jamming grip conforms to the unique shape of the user's ear. After a control is activated, a port evacuates air in the jamming grip, causing the material to “reversibly harden” in the same shape conforming to the user's ear. In embodiments, after evacuation, the cavity of the jamming grip can be a vacuum or a partial vacuum. A one-way air flow valve in the jamming grip prevents air from returning inside the cavity of the membrane, allowing the material to remain “hardened” and to maintain its molded geometry. Adjustments to the amount of air within the jamming grip can be maintained with passive or active devices.

In operation, embodiments of the jamming grip conform to each individual user's ear (e.g., the concha region) and are capable of maintaining a molded shape for an extended period of time (e.g., as long as the vacuum or partial vacuum is maintained within the sealed membrane). Embodiments of the jamming grip hold the earbud device in place and provide comfort and fit to a wide range of users.

Embodiments of the jamming grip utilize the compressibility and/or jamming phase behavior of the system to alter the rigidity of the earbud as it is in use. This approach takes advantage of both the conformable and rigid states of the system.

In embodiments of the present disclosure, the jamming grip can be removed, restored to its original conformable state, and reused to custom fit another user's ear. The jamming grip can further provide a custom fit to any user. The jamming grip can further minimizes the need to provide multiple sizes (e.g., small (S), medium (M), large (L)) to fit users. The jamming grip can further provide a compatible solution with helmets or other head gear with which headphones would interfere regularly.

In other embodiments, the jamming grip can also include (1) ear clips, (2) active springs, (3) spring elements incorporated into an earbud to press against parts of outer ear, (4) rubber earbud material that extends to more of the ear to both brace against other parts of the ear geometry and to increase contact surface area in general, or (5) material variation, such as use of multiple materials of varied durometer (e.g., plastic/rubber, memory foam, etc.) and granular/conformable materials (material type, packing density, etc.).

In other embodiments, the jamming grip may include and be integrated with ear device electronics. Other embodiments may feature an optimized shape for the elastic membrane and incorporate Zman gecko features into the elastic membrane. Zman gecko is further described in the following patent applications:
a) “Polymer Microwedges and Methods of Manufacturing Same” by Carter et al., U.S. Patent Publication No. 2017/0361508,
b) “Polymer Microwedges and Methods of Manufacturing Same” by Carter et al., U.S. Patent Publication No. 2017/0367418,
c) “Metal Molds for Polymer Microwave Fabrication” by Carter et al., International Publication Number WO 2016/094562, and
d) “Hybrid Adhesion System and Method” by Carter et al., U.S. Patent Publication No. 2017/0354847.

The teachings of the above applications are hereby incorporated by reference in their entirety.

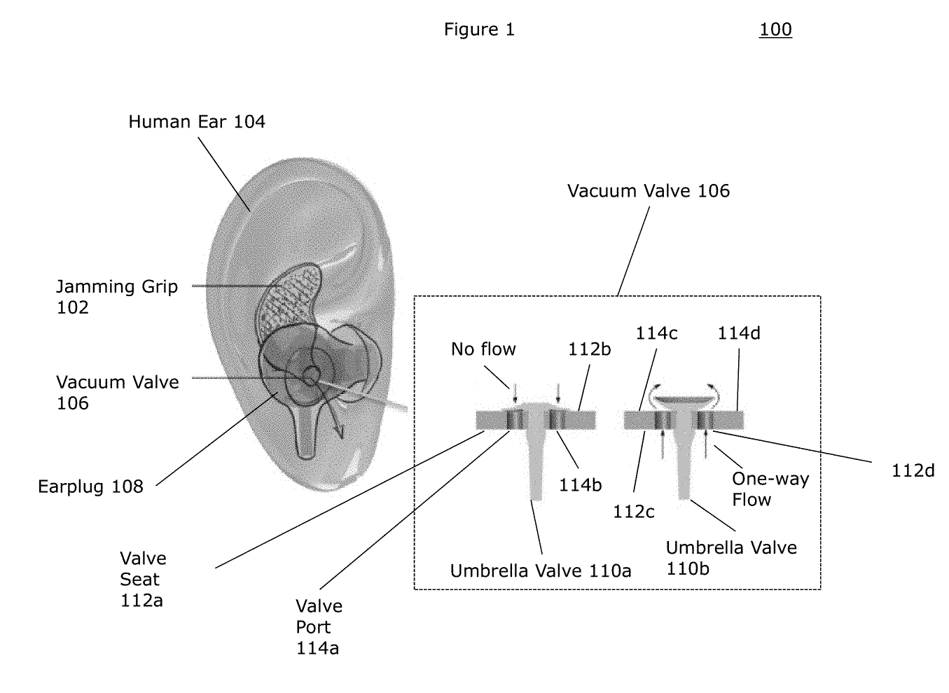

FIG. 1 is a high-level diagram 100 of an example embodiment of a jamming grip 102 of the present disclosure. The jamming grip 102 is part of an earplug 108 that is inserted into the human ear 104. The earplug 108 can be a traditional earplug (e.g., for blocking sound) or an earbud speaker. The earbud speaker can be wireless (e.g., Bluetooth or WiFi) or wired. The earbud speaker can include an audio controller (not shown), speaker (not shown), and, if wireless, a wireless network controller.

The jamming grip 102 includes a sealed membrane having granular or conformable material within, and a vacuum valve 106 that is configured to allow air to be removed from the sealed membrane to form a vacuum or partial vacuum. A partial vacuum reduces air pressure being a particular threshold that enables gripping with the jamming grip 102. Upon evacuation of air to be a vacuum or partial vacuum, the granular or conformable material within the sealed membrane locks into place, and the jamming grip 102 holds its shape. When the jamming grip 102 is in contact with another object, it takes a shape conforming to that object, and also has strong gripping properties to that particular object due to its conforming shape. In the example of FIG. 1, the jamming grip 102 conforms to a shape of a human ear 104, which helps hold the earplug 108 in place.

The vacuum valve 106 can be an umbrella valve 110a or 110b having a valve seat 112a-d and a valve ports 114a-d. The umbrella valve 110a shows the valve in the closed state, allowing no air flow through the valve ports 114a-b. The umbrella valve 110b is in an open state, allowing one way flow of air out of the sealed membrane through the uncovered ports 112c-d.

In another embodiment, the jamming grip 102 can include a second valve configured in reverse, such that activation allows air flow into the sealed membrane until the air pressure is equal or approximately equal to air pressure of the environment of the sealed membrane, and de-activation stops the flow of any air into the sealed membrane.

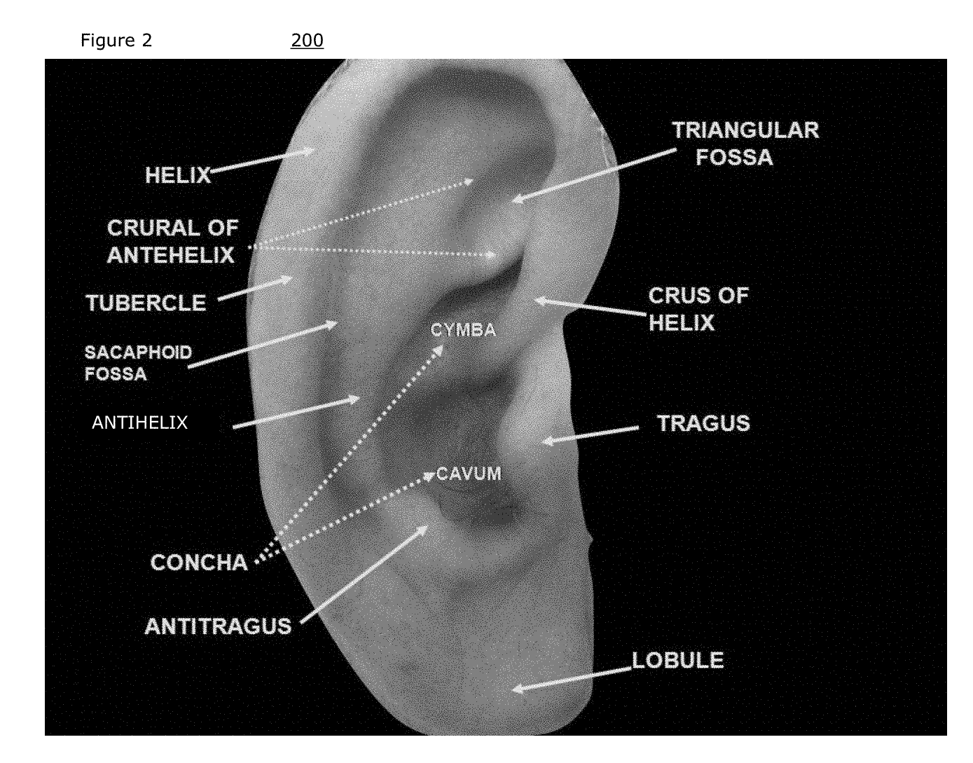

FIG. 2 is a diagram 200 illustrating nomenclature for parts of the human ear, as is known by a person of ordinary skill in the art. A person of ordinary skill in the art can recognize that definitions for parts of the human ear can include the following. The auricle, or pinna, is the visible part of the human ear that resides outside of the human head. The helix is the prominent rim of the auricle. The antihelix is a curved prominence of cartilage parallel with and in front of the helix on the auricle. The concha is a bowl-shaped part of the auricle nearest the ear canal and includes the cymba, the narrowest end of the concha, and the cavum. The tragus is a small pointed eminence of the external ear, situated in front of the concha and projecting back over the meatus. The antitragus is a small tubercle on the visible part of the ear.

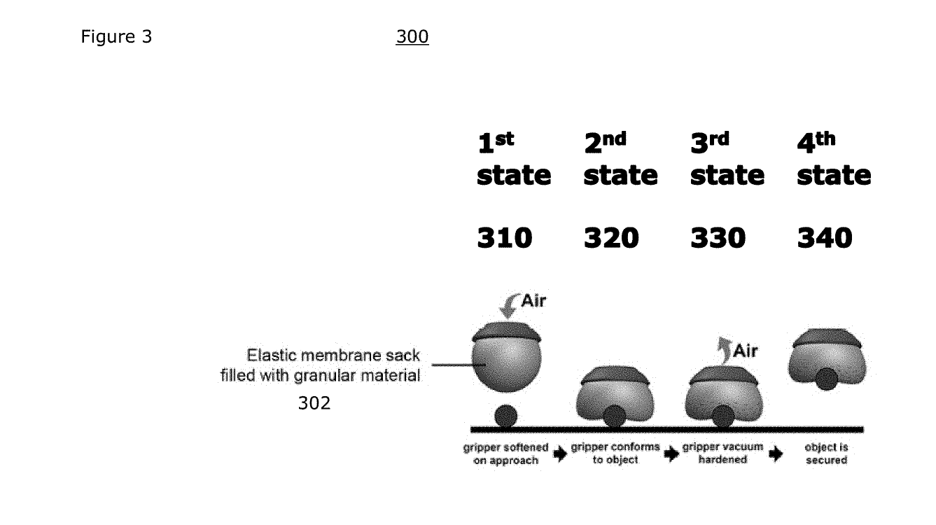

FIG. 3 is a diagram 300 illustrating an example embodiment of four states of a jamming grip. The jamming grip 302 illustrated in FIG. 3 includes an elastic membrane sack filled with a granular material, but can also be referred to as a sealed membrane with a cavity filled with granular or comfortable material. In a first state, the jamming grip 302 is filled with air (e.g., approximately equal air pressure inside the sealed membrane cavity as in the environment outside). In second state 320, the jamming grip is placed against an object, and the jamming grip conforms to the object. In a third state 330, while the jamming grip is applied to the object and conforms to the object, air is removed from the sealed membrane cavity. In a fourth state 340, air remains evacuated from the cavity of the sealed membrane of the jamming grip, and with the vacuum or partial vacuum maintained, the object is secured to the conformed surface of the jamming grip.

As described above, embodiments of the jamming grip 302 can reversibly harden and become conformable. The jamming grip 302 removes air from and refills air to the sealed cavity in a controlled, intentional manner using a port. In embodiments, controls can activate the port for removing air from the sealed cavity and refilling the sealed cavity with air. In other embodiments, air can be removed from the sealed cavity after application of pressure to the sealed cavity, such as from a speaker of the in-ear device, or a finger applying pressure to the sealed cavity.

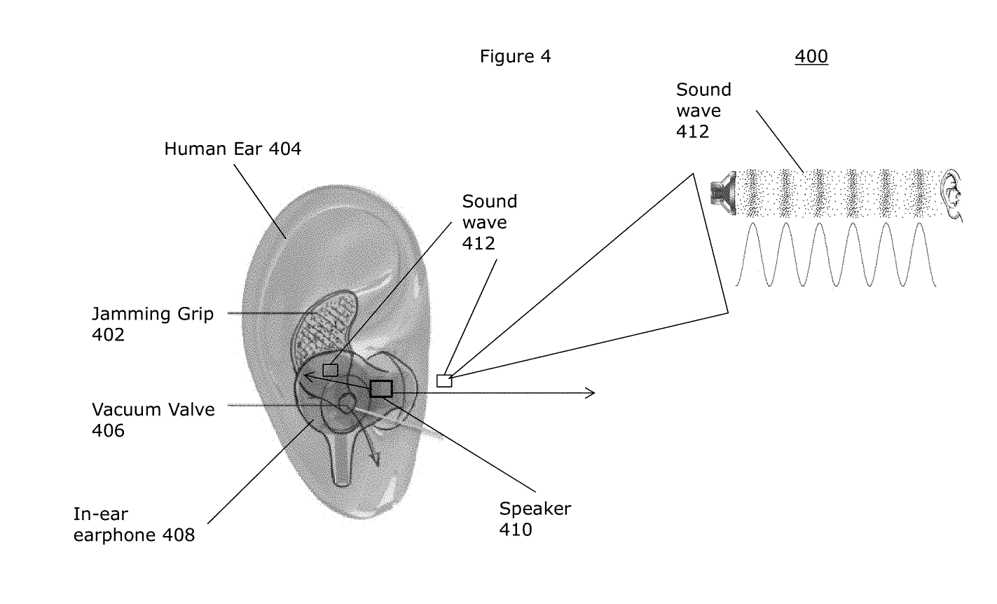

FIG. 4 is a diagram 400 illustrating a jamming grip 402 having a speaker 410 within. Like the jamming grip 102 of FIG. 1, the jamming grip 402 of FIG. 4 is placed within a human ear 404, is connected to an in-ear earphone 408, and is operatively connected to a vacuum valve/port 406. The speaker 410 is configured to produce sound waves 412 for the user to hear. A person of ordinary skill in the art can recognize that the sound waves 412 are waves of air pressure. Further, the sound waves 412 can travel in multiple directions, including through the jamming grip 402. In an embodiment, the air pressure of the sound waves 412 themselves can push air out through a one-way valve (e.g., the vacuum valve 406) until the cavity of the jamming grip is emptied of air beyond a certain threshold.

A person of ordinary skill in the art can recognize that in other embodiments, the jamming grip 402 and vacuum valve/port 406 can be configured such that sound waves 412 do not trigger evacuation of air, however.

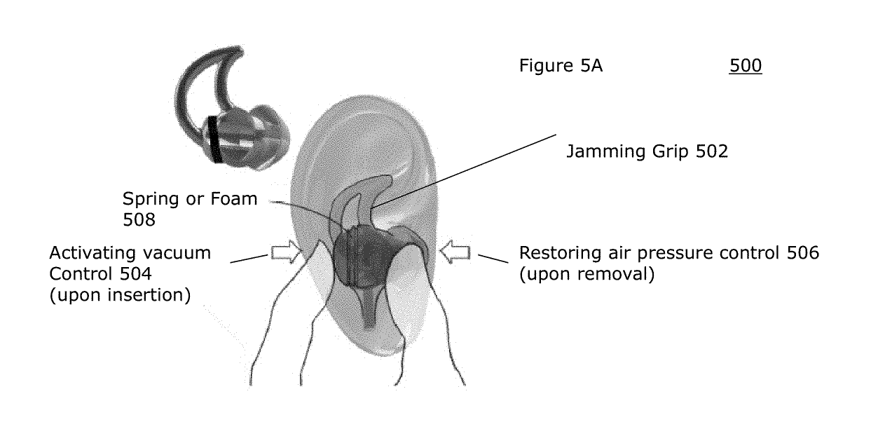

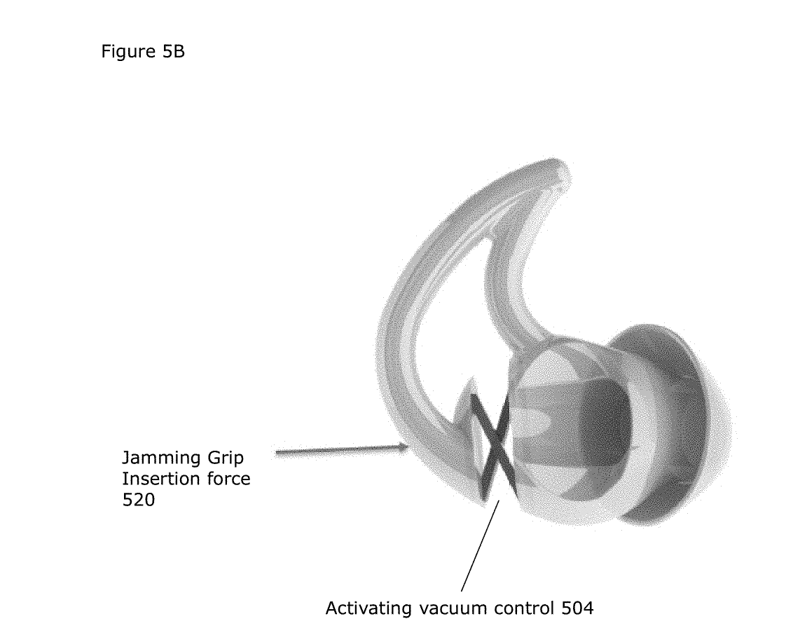

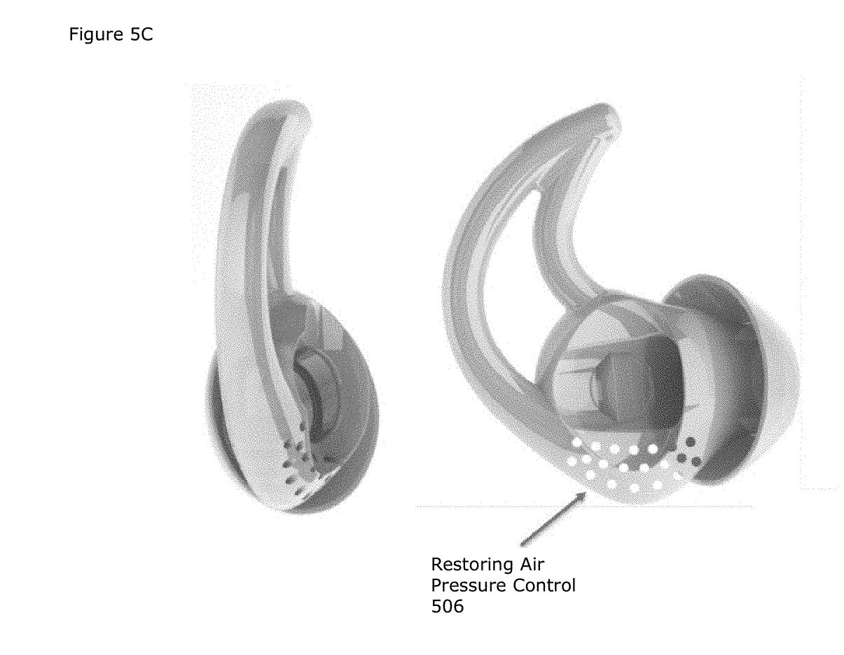

FIG. 5A is a diagram 500 illustrating additional features of an embodiment of the jamming grip 502 including valve activation controls.

The jamming grip 502 includes an activating vacuum control 504. In response to activating vacuum control 504 being activated, air is released from the sealed membrane cavity of the jamming grip 502. FIG. 5 illustrates the activating vacuum control 504 being activated upon pressure from the user's finger inserting the grip into the user's ear (e.g. from a button positioned in a location where a user applies pressure to insert the earbud of the jamming grip). FIG. 5B illustrates one example of such a control in further detail. However, other activating vacuum controls can be employed, such as an electronic or wireless control, a push button control that is agnostic to insertion of the jamming grip 502 into the user's ear, or activation of the control based on or by detecting sound waves or sound pressure from a speaker of the earbud connected to the jamming grip.

The jamming grip 502 further includes a restoring air pressure control 506. FIG. 5 illustrates the restoring air pressure control 506 as activating upon pressure from the user's finger removing the grip from the user's ear (e.g., from a button positions in a location where a user would apply pressure to remove the earbud of the jamming grip). FIG. 5C illustrates one example of such a control in further detail. However, other restoring air pressure controls can be employed, such as an electronic control, or a push button control that is agnostic to removal of the jamming grip 502 in the user's ear. In an additional embodiment of the electronic control, an electronic device can send a signal to restore air pressure to the restoring air pressure control 506 upon finishing playing an audio or audiovisual file or playlist.

The jamming grip 502 further can include a spring or foam portion 508. The spring or foam portion 508 can be between the activating vacuum control 504 and restoring air pressure control 506, and provide a physical buffer between the two controls 504 and 506.

FIG. 5B is a diagram illustrating an example embodiment of the restoring air pressure control 506. A jamming grip insertion force 520 presses against the earbud, which compresses the activating vacuum control 504. The activating vacuum control 504 is configured to activate the vacuum upon reception of a force above a particular threshold. The particular threshold is configured to occur in response to the earbud is inserted into the user's ear such that the jamming grip has conformed to the user's ear.

FIG. 5C is a diagram illustrating an example embodiment of the restoring air pressure control 506. In this embodiment, the restoring air pressure control 506 is a compressible elastic structure. A force pressing against the restoring air pressure control 506 above a particular threshold activates a valve that restores air pressure in the jamming grip, such that it can be released from the ear. The same motion should also gently push the earbud out of the user's ear after air pressure is restored.

Applicant further notes that while the above disclosure is directed to the human ear, other parts of the human body could be employed. For example, ski masks or a protective face mask could be secured to a face during athletic activity using similar miniature valves to control air pressure of the sealed membrane cavity. In another embodiment, orthotics such as orthopedic braces and air casts can further help patients by more securely conforming said orthotics to the patient.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A gripping ear-insert comprising:
a sealed membrane having conformable material therein, the sealed membrane configured to form a shape conforming to at least one section of the human ear upon insertion; and
a port configured to allow for adjustment of air pressure within the sealed membrane;
wherein in response to the port being activated, the port evacuates air from a cavity of the sealed membrane, such that the sealed membrane retains its shape after evacuation of the air.

2. The gripping ear-insert of claim 1, wherein pressure applied against the sealed membrane causes activation of the port, pushing air from the cavity of the sealed membrane through the port.

3. The gripping ear-insert of claim 1, wherein the port is a miniaturized valve.

4. The gripping ear-insert of claim 1, further comprising:
a control coupled with the port, configured such that in response to the control being activated, the port evacuates air from a cavity of the sealed membrane, such that the sealed membrane retains its shape after evacuation of the air.

5. The gripping ear-insert of claim 4, wherein the control is a mechanical button or electronic button.

6. The gripping ear-insert of claim 4, wherein the control is activated in response to a wireless signal.

7. The gripping ear-insert of claim 4, wherein the control is activated in response to positioning the gripping ear-insert within the at least one section of the human ear.

8. The gripping ear-insert of claim 1, wherein the sealed membrane is sized to fit and configured to conform to the shape of a human concha.

9. The gripping ear-insert of claim 1, further comprising:
an audio controller; and
a speaker.

10. The gripping ear-insert of claim 9, further comprising:
a wireless network controller.

11. The gripping ear-insert of claim 9, wherein air pressure from soundwaves produced by the speaker push air out of the membrane through the port.

12. The gripping ear-insert of claim 9, further comprising:
a control coupled with the port, configured such that in response to the control being activated, the port evacuates air from a cavity of the sealed membrane, such that the sealed membrane retains its shape after evacuation of the air;
wherein air pressure from soundwaves produced by the speaker causes the control to be activated.

13. The gripping ear-insert of claim 1, further comprising:
a second control coupled with the port, such that in response to the second control being activated, air enters the cavity of the sealed membrane of the gripping ear-insert, and such that the sealed membrane becomes conformable.

14. The gripping ear-insert of claim 1, further comprising:
an outer layer of the sealed membrane formed of Z-Man gecko material.

15. A method comprising:
positioning a gripping ear-insert within at least one section of a human ear, causing a sealed membrane of the gripping ear-insert to form a shape based on at least a portion of the at least one section of the human ear, the sealed membrane having conformable material therein; and
in response to activation of a port of the ear-gripping insert, evacuating air from a cavity of the sealed membrane of the gripping ear-insert through the port of the gripping ear-insert, such that the sealed membrane retains its shape after evacuation of the air.

16. The method of claim 15, wherein pressure applied against the sealed membrane causes activation of the port, pushing air from the cavity of the sealed membrane through the port.

17. The method of claim 15, wherein the port is a miniaturized valve.

18. The method of claim 15, further comprising activating a control, which responsively activates the port.

19. The method of claim 18, wherein the control is a mechanical button or electronic button.

20. The method of claim 18, wherein the control is activated in response to a wireless signal.

21. The method of claim 18, wherein the control is activated in response to positioning the gripping ear-insert within the at least one section of the human ear.

22. The method of claim 15, wherein the sealed membrane is configured to form a shape conforming to a human concha.

23. The method of claim 15, wherein the gripping ear-insert includes an audio controller and a speaker.

24. The method of claim 23, wherein the gripping-ear insert further includes a wireless network controller.

25. The method of claim 23, wherein air pressure from soundwaves produced by the speaker push air out of the membrane through the port.

26. The method of claim 23, wherein air pressure from soundwaves produced by the speaker causes a control to be activated, and the control responsively activates the port.

27. The method of claim 15, further comprising:
in response to activation of a second control coupled with the port, filling the cavity of the sealed membrane of the gripping ear-insert with air.

28. The method of claim 15, wherein the sealed membrane is within an outer layer of Z-Man gecko material.
